(19) United States
(12) Patent Application Publication
(10) Pub. No.: US 2012/0115487 A1
(43) Pub. Date: May 10, 2012

(54) Quality Control for Inter-Cell Handover

(76) Inventor: Nicolas Josso, La Chapell Saint Fray (FR)

(21) Appl. No.: 13/377,919

(22) PCT Filed: Jun. 16, 2010
(86) PCT No.: PCT/EP2010/058491

§ 371 Date: Dec. 13, 2011

(30) Foreign Application Priority Data
Jun. 18, 2009 (FR) 09 54130

(51) Int. Cl. H04W 36/08

(52) U.S. Cl. 455/437

(57) ABSTRACT

A method and apparatus for deciding whether the handover has to be done or not, where the decision is taken by the mobile unit. The mobile unit can reject the command from the base station if the quality of the communication might not be maintained in the second network. This decision is taken measuring some quality parameters of the second network and comparing them with a predefined threshold.

### TECHNICAL DOMAIN

The present invention generally relates to the domain of integrated circuits used in the domain of wireless communications.

More particularly, it concerns the functionality of transferring a communication (handover) between two cells of a wireless communications network.

The invention has applications particularly in the integrated circuits equipping wireless mobile telephones.

### TECHNOLOGICAL BACKGROUND

In cellular communications, the communication network is divided into cells. For example, in the GSM network each cell is covered by a Base Transceiver Station (BTS) which is controlled by a Base Station Controller (BSC).

A mobile communication device at a given location may be within the coverage of multiple cells. In such cases, it is possible to select the best base station to use. The change from the current cell to another cell is called an inter-cell handover or handoff. This handover is controlled by network management units.

There can be several reasons for such a handover, including:

when the transmission quality between the mobile communication device and the current base station weakens, which is the case for example when the device is moving from the current cell to another,
when the mobile communication device is subject to interference from other devices located in the current cell, and
when the communication traffic is too high for the current base station.

### PRIOR ART

In order to detect the possibility of performing an inter-cell handover, a certain number of measurements must be made.

Some of these measurements are made by the mobile communication device, which sends them on to the network management units. The relevance of these measurements then depends on the radio reception conditions, the mobility of the device, and the delay between the moment of the measurement and the triggering of the handover.

In order to guarantee good quality of service on the network, the measurements for a handover should be done as often as possible in order to be able to trigger the handover at the right moment.

For example, in the GSM 3GPP standard, the measurements consist of identifying the base station to which the communication will be transferred by reading the Base Station Identity Code (BSIC) message, then reading the Received Signal Strength Information (RSSI) message indicating the intensity of the signal between the mobile communication device and the base station. Thus the BSIC is only used to identify the base station.

The measurement is done at a high frequency (multiple measurements at 480 ms intervals). However, this type of measurement is not always sufficient to ensure communication quality within a cell.

Section 7.2 of the 3GPP 45.008 standard specifies that the mobile communication device must retrieve information from BSIC messages as often as possible, and at least every 10 seconds.

If holding to the minimum required by the standard, 10 seconds could pass between a measurement made for the purposes of a handover and the handover itself. This lapse of time, particularly under poor radio reception conditions, could result in an incorrect handover decision, for example changing from the current cell to a cell in which the communication is of a lower quality. This could even result in the loss of the current communication.

In the prior art, the required handovers are therefore always performed, ignoring the communication quality in the cell to which the communication will be transferred.

If it is impossible to obtain the RSSI and BSIC from the cell to which the communication is to be transferred, mechanisms exist for detecting a handover failure.

However, this procedure can take too long to reestablish the link to the initial cell and avoid losing the current communication.

In one particular case, the 3GPP standard allows for inter-cell handover to a cell with which the mobile communication device is not synchronized. This type of handover is sometimes called a blind handover.

In such a procedure, the communication device which receives a handover request will attempt to synchronize with the cell to which the communication is to be transferred. If the synchronization fails, the device notifies the network of a handover failure, otherwise it transfers the communication.

In this procedure, however, the decision to hand over the communication remains the responsibility of the network and the mobile communication device can only give notification of a handover failure if synchronization is impossible.

### SUMMARY OF THE INVENTION

There is a need for a technique to allow an inter-cell handover that is effective in the large majority of cases, meaning a handover which does not lose the current communication, and to avoid a handover from a current cell to a new cell in which the communication quality will be lower, meaning a handover which takes into account the continuity of the quality of service.

For this purpose, a circuit is proposed for a communication terminal adapted to communicate via a telecommunication network divided into cells. This circuit is configured to:

receive a command to hand over a communication in progress from a first cell to a second cell,
obtain a measurement of the communication quality in the second cell,
compare the measurement obtained with a reference threshold value, and
perform the handover if the measurement obtained is greater than or equal to the threshold value or reject the handover request if the obtained measurement is less than the threshold value, and wherein the quality measurement is obtained by decoding information issuing from the second cell.

In this manner, when the network orders an inter-cell handover, the terminal can contribute to the transfer decision by measuring the quality.

Unlike the prior art where the terminal cannot refuse an inter-cell handover once it is synchronized with the cell, the invention allows maintaining a communication quality in spite of changing cells.

The quality measurement is obtained by decoding information issuing from the second cell.

In this manner the quality measurement does not require the implementation of additional means within the network.

In some embodiments, the quality measurement is obtained by reading the information characterizing the second cell available on the network.

Therefore the advantages offered by the invention are obtained without adding further complexity to the network.

Also proposed is a mobile telecommunications terminal comprising a circuit as presented above, a control method for such a circuit, and a computer program comprising instructions for implementing said method when it is loaded into a processor and executed.

These objects present at least the same advantages as those associated with the circuit of the invention.

### BRIEF DESCRIPTION OF THE DRAWINGS

Other features and advantages of the invention will become apparent from the following description. This description is purely illustrative and is to be read in light of the attached drawings, in which:

FIG. 1 illustrates a general context for implementing embodiments of the invention;

FIG. 2 illustrates a mobile terminal according to embodiments of the invention;

FIG. 3 is a general flow chart of an implementation of the method according to embodiments of the invention.

### DETAILED DESCRIPTION OF EMBODIMENTS

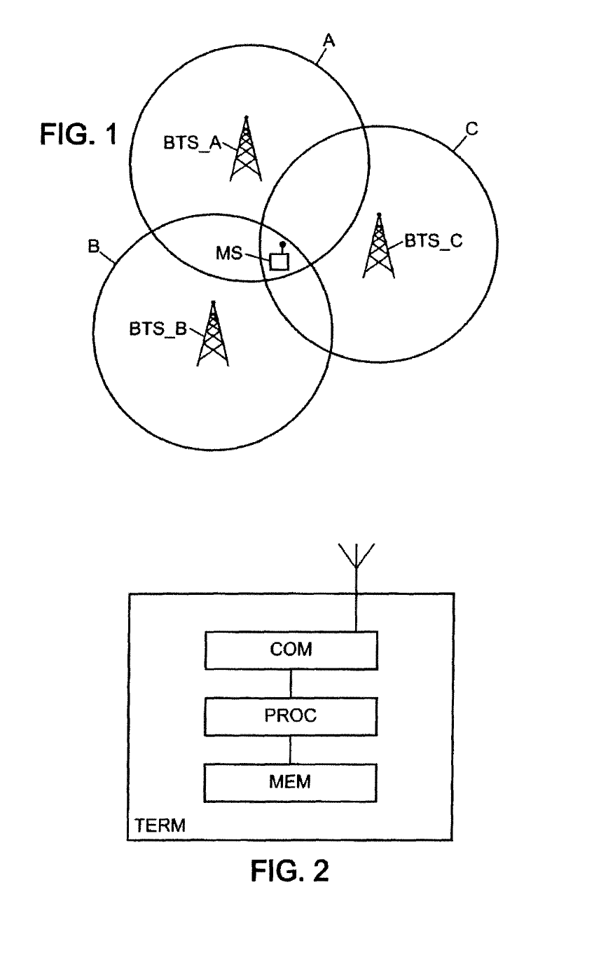

FIG. 1 illustrates a general context for implementing embodiments of the invention.

In this figure, three base stations BTS_A, BTS_B, and BTS_C are arranged such that their radio coverage areas A, B, and C, or cells, overlap. A region covered by three cells exists in this example. It is assumed that there is a mobile communication terminal MS (for Mobile Station) within this zone.

For the example, the terminal is considered to be moving from zone A where it initiated a communication involving the base station BTS_A, towards zone B.

The network management entities used for the communication (not represented) will trigger a handover of the communication from cell A to cell B in order to ensure continuity of the communication in spite of the change of cell.

An embodiment of a mobile terminal according to embodiments of the invention is now described with reference to FIG. 2.

This terminal TERM comprises a communication unit COM for communicating via the communication network comprising in particular the network management units and the base stations mentioned above.

The terminal also comprises a control unit PROC and a memory MEM for performing the necessary processing, particularly for the communication, and for the inter-cell handover.

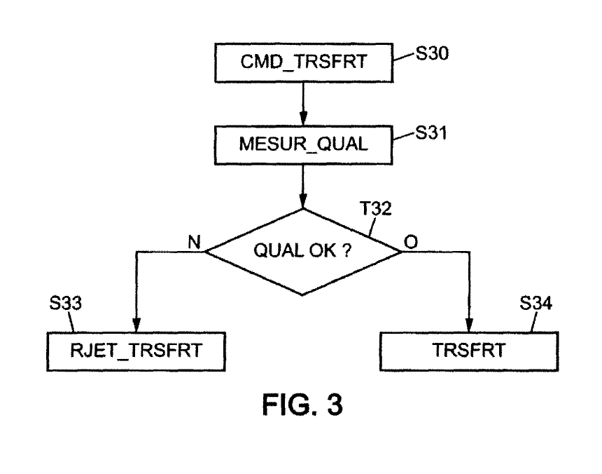

In particular, the control unit comprises a circuit configured to perform the operations which are described below with reference to FIG. 3.

First, during the step S30, the circuit receives an inter-cell handover command to transfer from cell A to cell B.

This command is issued by the network management units, for example according to the 3GPP standard. This command is received via the communication unit.

Upon receipt of this command, the circuit obtains a measurement of the communication quality in cell B, in the step S31.

This measurement is intended to verify that the communication conditions in cell B are suitable for maintaining the quality of the communication initiated in cell A.

This measurement is described in more detail below.

When the quality measurement has been obtained, in the step T32 the circuit compares the obtained measurement to a threshold value for the quality necessary for allowing an inter-cell handover which maintains the communication quality.

If the quality measurement is sufficient, the handover is performed in the step S34. The details of implementing such a handover can, for example, be found in the 3GPP standard.

However, if the quality measurement is insufficient, in the step S33 the circuit sends a handover rejection to the network management units.

Rejection notifications can be made in compliance with the ones existing in the 3GPP standard.

The processing of such notifications can also be performed according to this standard.

In this manner these units can react, for example, by selecting another cell for the handover. In the example illustrated in FIG. 1, the management units can for example choose cell C, which partially covers cell B.

The quality measurement as described above will then be measured once again.

If there is no relevant cell of sufficient quality to hand the terminal over to, the network can force the handover to a given cell in a manner independent of the method described above.

The quality measurement can consist of reading information, concerning the cell to which the handover is to be made, which is directly or indirectly representative of the communication quality in the cell.

For example, this can involve reading information made available on the network for this purpose.

It is also possible to use information already available on the network for another purpose. In such case, this information is processed in order to deduce the communication quality in the cell. Several examples of such information are given below.

In one embodiment in a 2G network, the quality measurement is obtained by reading the two pieces of information RxLev and BSIC.

In this embodiment, and unlike the prior art, the two pieces of information are processed in order to produce a measurement of the quality within the cell. RxLev gives information on the intensity of the signals exchanged between the terminal and the base station, while this information is independent of the communication conditions in the cell. As for the BSIC, it is encoded and sent over the network, and so the circuit which decodes this message can deduce the communication quality in the cell, for example by determining a decoding failure rate for this message.

In one embodiment in a 3G network, the quality is measured by reading the two pieces of information RSCP (Received Signal Code Power) and CPICH (Common Pilot Channel). This set of information offers at least the same advantages as those provided by the RxLev-BSIC pair.

The threshold value to which the quality measurement is compared can be determined as a function of the quality of service that one wants to maintain for communications. This threshold value can therefore be configured according to the requirements one wants to apply.

In one embodiment, this threshold value corresponds to the communication quality measured in the original cell A.

A computer program for implementing the circuit control method can be realized as shown in the general flow chart in FIG. 3. Such a program can be implemented by the control unit PROC of a terminal TERM according to the embodiment described above.

Of course, the invention is not limited to the embodiments described above. It extends to all equivalent variations.

1-6. (canceled)

7. A circuit for a communication terminal adapted to communicate via a telecommunications network that is divided into cells, the circuit being configured to:
receive an instruction to handover to a second cell a communication in progress in a first cell;
obtain a measurement of the communication quality in the second cell from cell identification information issuing from the second cell;
compare the obtained measurement to a reference threshold value; and
perform the handover if the obtained measurement is greater than or equal to the threshold value, or otherwise reject the handover request if the obtained measurement is less than the threshold value.

8. (canceled)

9. A method for controlling a circuit in a communication terminal adapted to communicate via a telecommunications network that is divided into cells, comprising:
receiving an instruction to handover to a second cell a communication in progress in a first cell;
obtaining a measurement of the communication quality in the second cell from cell identification information issuing from the second cell;
comparing the obtained measurement to a reference threshold value; and
performing the handover if the obtained measurement is greater than or equal to the threshold value, or otherwise rejecting the handover request if the obtained measurement is less than the threshold value.

10. (canceled)

11. A computer program product stored in a non-transitory computer-readable medium, said computer program product comprising instructions for processing handover instructions in a telecommunications network, which, when run on a mobile communication terminal, configures the mobile terminal to:
receive an instruction to handover to a second cell of the network a communication in progress in a first cell of the network;
obtain a measurement of the communication quality in the second cell from cell identification information issuing from the second cell;
compare the obtained measurement to a reference threshold value; and
perform the handover if the obtained measurement is greater than or equal to the threshold value, or otherwise reject the handover request if the obtained measurement is less than the threshold value.

12. A mobile communication terminal comprising:
a communication unit for communicating via a telecommunications network that includes a first cell and a second cell;
a memory unit; and
a control unit operatively connected to the communication unit and the memory unit, the control unit being configured to:
receive an instruction to handover to the second cell a communication in progress in the first cell;
obtain a measurement of the communication quality in the second cell from cell identification information issuing from the second cell;
compare the obtained measurement to a reference threshold value; and
perform the handover if the obtained measurement is greater than or equal to the threshold value, or otherwise reject the handover request if the obtained measurement is less than the threshold value.

13. The circuit of claim 7, wherein the circuit is configured to obtain a measurement of the communication quality in the second cell by determining a decoding failure rate for the cell information issuing from the second cell.

14. The circuit of claim 7, wherein telecommunications network is a 2G network, and the cell identification information includes a Base Station Identity Code (BSIC).

15. The circuit of claim 14, wherein the measurement of the communication quality in the second cell is obtained using RxLev together with the BSIC.

16. The circuit of claim 7, wherein the telecommunications network is a 3G network, and the cell identification information includes the Common Pilot Channel (CPICH).

17. The circuit of claim 16, wherein the measurement of the communication quality in the second cell is obtained using a Received Signal Code Power (RSCP) together with the CPICH.

18. The method of claim 9, wherein obtaining a measurement of the communication quality in the second cell from cell identification information issuing from the second cell comprises determining a decoding failure rate for the cell identification information.

19. The method of claim 9, wherein telecommunications network is a 2G network, and the cell identification information includes a Base Station Identity Code (BSIC).

20. The method of claim 19, wherein the measurement of the communication quality in the second cell is obtained using RxLev together with the BSIC.

21. The method of claim 9, wherein the telecommunications network is a 3G network, and the cell identification information includes the Common Pilot Channel (CPICH).

22. The method of claim 21, wherein the measurement of the communication quality in the second cell is obtained using a Received Signal Code Power (RSCP) together with the CPICH.
